(19) United States
(12) Patent Application Publication
(10) Pub. No.: US 2007/0292153 A1
(43) Pub. Date: Dec. 20, 2007

(54) Image forming apparatus

(76) Inventor: Sakiko Araya, Yokohama-shi (JP)

Correspondence Address: CLARK & BRODY, 1090 VERMONT AVENUE, NW, SUITE 250, WASHINGTON, DC, 20005, US

(21) Appl. No.: 11/806,028

(22) Filed: May 29, 2007

(30) Foreign Application Priority Data
May 29, 2006 (JP) 2006-147979

(51) Int. Cl. G03G 15/10

(52) U.S. Cl. 399/58

(57) ABSTRACT

An image forming apparatus of a tandem developing type is designed so that each of toners has an average circularity Cn of 0.89 or more (Cn indicates an average circularity of the toner in a developer to be transferred in the n-th time, where n is an integer of 1 to N, with N indicating the total number of colors of the toners that form an image), with C1≦C2≦ . . . ≦CN and C1<CN (where n>1) being respectively satisfied. An amorphous silicon photosensitive member is used in an image forming apparatus of the tandem developing type.

Priority is claimed to Japanese Patent Application No. 2006-147979 filed on May 29, 2006, the disclosure of which is incorporated by reference in its entirety.

### BACKGROUND OF THE INVENTION

1. Field of the Invention

The present invention relates to an image forming apparatus, such as a copying machine, a printer and a facsimile, that utilizes an electrophotographic system, and a composite machine including these, and more particularly concerns a full-color image forming apparatus which has a plurality of image forming units, each having a single color, and forms a full-color image by successively superposing toner images.

2. Description of Related Art

Conventionally, with respect to the color image forming apparatus, a single-drum color-superposing system which successively forms a plurality of color images on a photosensitive member has been proposed. In this system, by accurately superposing toners on the photosensitive member, it is possible to form a color image that is free from color deviations, and this system has received much attention as a technique that can improve the quality of color images. However, since upon forming a color image, a system is used, in which the above-mentioned images of respective colors are successively formed on the photosensitive member so as to allow, for example, images having respectively different four colors (for example, C, M, Y, K) to be superposed on one after another on the single photosensitive member, the resulting problem is that a long time is required before a color image is finally formed.

In recent years, image forming apparatuses of a tandem system have been often used, and in this system, a plurality of photosensitive members are prepared, and the respective photosensitive members are simultaneously scanned and exposed by using a plurality of light beams to form images having mutually different colors on the respective photosensitive members, and by superposing the images of respective colors on the same transferring medium, a color image is formed. This system has advantages of high image quality and high-speed performance.

In order to reduce the running cost and achieve a long service life of the machine, amorphous silicon drums have been widely used as the photosensitive members. The amorphous silicon drum has high surface hardness, and even after having been ground by inorganic fine particles on the toner surface, the surface film is hardly subjected to abrasion so that it becomes possible to achieve the long service life of the machine without a reduction in the performances.

However, the amorphous silicon drum has a characteristic that its friction resistance is high, and when this is applied to an image forming apparatus of a tandem system, the resulting problem is that “loss-in-character phenomenon”, in which the toner on the transferring member has a loss inside the line image, tends to occur. That is, in the case when the output image pattern is a mono-color image corresponding to the first developing position color, the first development toner, transferred onto the transferring member, is made in contact with the photosensitive drum in a second developing area, with the result that the outermost surface layer of the toner layer on the transferring member is taken away by the photosensitive drum by a toner adhesive strength between the photosensitive drum and the toner. In the same manner, in a third developing area as well as in a fourth developing area, the toner is also taken away by the drum, with the result that “loss-in-character phenomenon” is caused.

In order to suppress this loss-in-character phenomenon, for example, Japanese Patent Publication No. 2003-84489A has proposed a structure in which in the tandem developing system, the adhesive strength between the toner and the transferring member is made greater than the adhesive strength between the toner and the drum, with the adhesive strength between the second transferring member and the toner being made greater than the adhesive strength between the first transferring member and the toner. In this structure, however, since the average circularity of the toner is 0.95 or more, it is not possible to completely suppress the loss-in-character phenomenon in the case of an amorphous silicon drum having high frictional resistance. This reason is as follows. That is, in the case when a toner having a higher average circularity is put on the upstream side (the side on which a toner image is transferred first is referred to as “upstream side”), the toner tends to be reversely transferred onto a drum on the downstream side. As a result, a transferring efficiency is lowered.

Moreover, with respect to the means for reducing the frictional resistance, a method has been proposed in which metal soap is contained in a toner to be used so as to coat the surface of the image supporting member. For example, Japanese Patent Publication No. 2005-31243A has proposed a method in which, in order to prolong the life of the latent image supporting member, metal soap is contained in a toner to be used so as to coat the surface of the image supporting member so that the amount of film abrasion of the image supporting member is reduced. However, the application of the metal soap raises problems in which the developer transporting force of the developing sleeve is lowered and the charge of the developer is lowered.

### SUMMARY OF THE INVENTION

One of the advantages of the present invention is to provide an image forming apparatus which, even in the case when an amorphous silicon photosensitive member is used in an image forming apparatus of a tandem developing system, provides a superior transferring efficiency and is free from a loss-in-character phenomenon.

The image forming apparatus in accordance with the present invention is provided with: a plurality of electrostatic latent image supporting members that are placed along a moving direction of a transferring medium, and successively transfers a toner image on the transferring medium; and a plurality of developer supporting members that supply toners of developers onto the electrostatic latent image supporting members so as to form toner images thereon, and in this structure, each of the toners has an average circularity Cn of 0.89 or more (Cn indicates an average circularity of the toner in a developer to be transferred in the n-th time, where n is an integer of 1 to N, with N indicating the total number of colors of the toners that form an image), with C1≦C2≦ . . . ≦CN and C1<CN (where n>1) being respectively satisfied. Thus it can be supressed that the toner is reversely transferred onto a photosensitive member on the downstream side by lowering an average circularity of the toner on the upstream side more than one of the toner on the downstream side.

The image supporting member is preferably prepared as an amorphous silicon photosensitive member. Moreover, preferably, the image forming apparatus is of a color 4-drum tandem developing type.

Furthermore, the image forming apparatus of the present invention is preferably designed so that the C1 is in a range of 0.89 to 0.92, the C2 is in a range of 0.91 to 0.94, the C3 is in a range of 0.93 to 0.96 and the C4 is in a range of 0.95 to 0.98.

In accordance with the present invention, even in the case when an amorphous silicon photosensitive member is used in an image forming apparatus of a tandem developing system, it is possible to provide an image forming apparatus that has a superior transferring efficiency and is free from a loss-in-character phenomenon.

### BRIEF DESCRIPTION OF THE DRAWINGS

FIG. 1 is a schematic view showing an image forming apparatus in accordance with one embodiment of the present invention.

### DESCRIPTION OF PREFERRED EMBODIMENTS

The present invention relates to a color image forming apparatus of a tandem type in which a plurality of image supporting members (hereinafter, referred to as photosensitive drum), made of amorphous silicon, are placed on transferring media, such as an intermediate transferring belt, an intermediate transferring drum and a transferring transport belt, in this structure, each of the toners to be used has an average circularity Cn of 0.89 or more (Cn indicates an average circularity of the toner in a developer to be transferred in the n-th time, where n is an integer of 1 to N, with N indicating the total number of colors of the toners that form an image), with C1≦C2≦ . . . ≦CN and C1<CN (where n>1) being respectively satisfied. Preferably, the above-mentioned image supporting member is an amorphous silicon photosensitive drum.

In the tandem developing system using an amorphous silicon photosensitive drum, the toner that has been developed on the photosensitive drum at a first developing position is primary-transferred onto a transferring member such as a transfer belt or a transfer drum. As mentioned above, in the case when the output image pattern is a mono-color image corresponding to the first developing position color, the first development toner, transferred onto the transferring member, is made in contact with the photosensitive drum in a second developing area, with the result that the outermost surface layer of the toner layer on the transferring member is taken away by the photosensitive drum. In the same manner, in successive developing areas, the toner is also taken away by the drum, with the result that the loss-in-character phenomenon is caused.

Here, in the case when a toner having a higher average circularity is put on the upstream side, since the toner tends to be reversely transferred onto a drum on the downstream side, the transferring efficiency is lowered. However, each of the toners in the respective developing devices is allowed to have an average circularity Cn that satisfies C1≦C2≦ . . . ≦CN so that the reverse transfer can be suppressed with superior transferring efficiency being maintained. In this case, however, supposing that C1=CN holds when n>1 (that is, N is the final number), the toner of the first development tends to be reversely transferred onto a photosensitive member on the downstream side, resulting in a higher possibility of the loss-in-character; therefore, C1<CN needs to be satisfied.

The image forming apparatus of the present invention is desirably applied to a color 4-drum tandem electrophotographic system, and in this case, with C1≦C2≦C3≦C4 being satisfied, preferably, the C1 is set in a range of 0.89 to 0.92, the C2 is set in a range of 0.91 to 0.94, the C3 is set in a range of 0.93 to 0.96 and the C4 is set in a range of 0.95 to 0.98. When the average circularity is below 0.89, the transferring efficiency deteriorates, and when it exceeds 0.98, toner scattering tends to occur.

Here, the average circularity of toner particles are obtained from processes in which: measurements are conducted by using a flow-type particle image analyzer or the like, the average circularity of the measured particles is obtained from the following equation (1), and the total sum of the average circularities of all the measured particles is divided by the number of all the particles so that the resulting value is used as the average circularity of the toner.
Average circularity C=L₀/L (1)

In this equation (1), L₀ represents the peripheral length of a circle having the same projection area as the particle image, and L represents the peripheral length of the particle image.

(Toner)

With respect to the toner of the present invention, a toner obtained by a pulverization classifying method may be used, and from the viewpoint of obtaining a toner having a high degree of average circularity, a polymerizing method toner obtained by a suspension polymerizing method, an emulsification polymerizing condensation method and the like may also be used. Moreover, a toner obtained by a fusion granulating method or a spray granulating method may be used.

In the pulverization classifying method, first, a charge control agent, mold releasing agent, etc. are added to a binder resin, colorant and magnetic powder, if necessary, so that a toner composite is prepared. Next, after having been preliminarily mixed by a Henschel mixer, a V type mixer or the like, this is melt-kneaded by using a melt kneader such as a twin-axis extruder, etc. After this melt-kneaded matter has been cooled, the resulting matter is coarsely pulverized and finely pulverized, and is classified, if necessary, so that toner particles having a predetermined average circularity are obtained. The volume average particle size of the toner is preferably set in a range from 6 μm to 14 μm.

The above-mentioned binder resin, colorant, magnetic powder, charge control agent and mold releasing agent are not particularly limited, and those of conventionally known materials may be used.

In the suspension polymerizing method, a colorant, wax, a charge control agent, a crosslinking agent and the like are dispersed in a polymerizable monomer, and the monomer compound after the dispersing treatment is stirred in an aqueous medium (for example, water or a mixed solvent between water and a water mixable solvent) to prepare an appropriate particle size, and to this is added a polymerization initiator and heated so that the polymerizable monomer is polymerized to obtain a spherical toner particles having a high degree of circularity.

The above-mentioned colorant, wax, charge control agent, crosslinking agent and polymerization initiator are not particularly limited, and those of conventionally known materials may be used.

In the emulsification polymerizing condensation method, in general, a resin dispersion solution is prepared through emulsion polymerization, and separately, an additive dispersion solution in which a colorant, wax, a charge control agent and the like are dispersed in a solvent is prepared, and these are mixed to form aggregated particles corresponding to the toner particle size, and these are then fused with one another by applying heat thereto so that spherical toner particles are obtained.

Next, to the resulting toner particles, a predetermined amount of an inorganic oxide and a surface treatment agent such as silica, if necessary, are externally added, and the resulting particles are stirred and mixed by a mixing device such as a Henschel mixer to provide a toner.

With respect to the toner relating to the present invention, the toner thus obtained is mixed with a carrier so that the resulting developer is used as a two-component full-color developer.

The toner density in the two-component developer is set in a range from 1 to 20% by mass, preferably, from 3 to 15% by mass. When the toner density is less than 1% by mass, the image density might become too thin. In contrast, when the toner density exceeds 20% by mass, toner scattering occurs in the developing device, to cause problems, such as contamination inside the machine and adhesion of the toner to background portions of a sheet of copy paper or the like.

(Binder Resin)

With respect to the binder resin, although not particularly limited in its kinds, preferable examples thereof include: thermoplastic resins, such as polystyrene-based resin, acryl-based resin, styrene-acryl-based copolymer, polyethylene-based resin, polypropylene-based resin, polyvinyl chloride-based resin, polyester-based resin, polyamide-based resin, polyurethane-based resin, polyvinyl alcohol-based resin, vinyl ether-based resin, N-vinyl-based resin, and styrene-butadiene resin.

More specifically, with respect to the polystyrene-based resin, an independent polymer of styrene, or a copolymer between styrene and another copolymerizable monomer capable of copolymerizing with styrene may be used. With respect to the copolymerizable monomer, examples thereof include: p-chlorostyrene; vinyl naphthalene; ethylene unsaturated mono-olefins, such as ethylene, propylene, butylene, and isobutylene; halogenated vinyl, such as vinyl chloride, vinyl bromide and vinyl fluoride; vinyl esters, such as vinyl acetate, vinyl propionate, vinyl benzoate and vinyl butyrate; (meth)acrylic acid esters, such as methyl acrylate, ethyl acrylate, n-butyl acrylate, isobutyl acrylate, dodecyl acrylate, n-octyl acrylate, 2-chloroethyl acrylate, phenyl acrylate, α-chloromethyl acrylate, methyl methacrylate, ethyl methacrylate and butyl methacrylate; other acrylic acid derivatives, such as acrylonitrile, methacrylonitrile and acryl amide; vinyl ethers, such as vinyl methylether, vinyl isobutylether; vinyl ketones, such as vinylmethyl ketone, vinylethyl ketone, methylisopropenyl ketone; and N-vinyl compounds, such as N-vinyl pyrrole, N-vinyl carbazole, N-vinyl indole, and N-vinyl pyrrolidene. One kind of these may be used alone, or two or more kinds of these may be combined, and copolymerized with a styrene monomer.

The polystyrene-based resin preferably has two mass-average molecular weight peaks (low molecular weight peak and high molecular weight peak). More specifically, the low molecular weight peak is located within a range of 3,000 to 20,000, and the high molecular weight peak is located within a range of 300,000 to 1,500,000, and it is desirable to set the ratio (Mw/Mn) of a mass average molecular weight (Mw) and a number average molecular weight (Mn) to 10 or more. If there is a mass average molecular weight peak within this range, a toner can be fixed easily and the offset resistant property can also be enhanced. In addition, the mass average molecular weight and number average molecular weight of the binder resin can be measured through processes in which: by using a molecular weight measuring apparatus (GPC), the elution time from a column is measured, and by comparing this with an analytical curve that has been preliminarily formed by using standard polystyrene resin, those values are obtained.

With respect to the polyester-based resin, what is obtained by condensation polymerization or co-condensation polymerization of an alcohol component and a carboxylic acid component can be used. With respect to the components to be used upon compounding the polyester-based resin, the following materials are used.

Examples of dihydric or trihydric or more alcohol components include: diols, such as ethyleneglycol, diethyleneglycol, triethyleneglycol, 1,2-propyleneglycol, 1,3-propyleneglycol, 1,4-butanediol, neopentylglycol, 1,4-butenediol, 1,5-pentanediol, 1,6-hexanediol, 1,4-cyclohexanedimethanol, dipropyleneglycol, polyethyleneglycol, polypropyleneglycol and polytetramethyleneglycol; bisphenols, such as bisphenol A, hydrogenated bisphenol A, polyoxyethylenated bisphenol A and polyoxypropylenated bisphenol A; and trihydric or more alcohols, such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

With respect to dihydric or trihydric or more carboxylic acid components, dihydric or trihydric carboxylic acids and anhydrides or lower alkyl esters of these are used, and examples thereof include: dihydric carboxylic acids, such as maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or alkyl or alkenyl succinic acids, such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid and isododecenyl succinic acid; and trihydric or more carboxylic acids, such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid and empol trimer acid.

The softening point of the polyester-based resins measured by a Koka type flow tester is preferably set in a range from 110 to 150° C., more preferably, from 120 to 140° C.

Moreover, with respect to the binder resin, thermoplastic resin is preferably used from the viewpoint of good fixability; however, thermosetting resin may also be used as long as the amount of crosslinked portions (the amount of gels), measured by using a Soxhlet extractor, is set to a value of 10% by mass or less, preferably, in a range from 0.1 to 10% by mass. Thus, by introducing a crosslinking structure partially, the preservation stability and shape retaining property of a developer, or the durability thereof can be further improved, without reducing the fixability. Therefore, it is not necessary to use 100% by mass of thermoplastic resin as a binder resin for the toner base material, and a crosslinking agent can be added thereto, or a thermosetting resin can also be used partially.

With respect to the thermosetting resin, epoxy-based resin, cyanate-based resin, etc. may be used. Specifically, one kind or two kinds or more of the following resins may be used in combination: bisphenol A type epoxy resin, hydrogenated bisphenol A type epoxy resin, a novolak type epoxy resin, polyalkylene ether type epoxy resin, cyclic fatty type epoxy resin, and cyanate resin.

Moreover, with respect to the binder resin, in order to improve the dispersibility of magnetic powder, it is desirable to use the resin which has in a molecule at least one functional group selected from the group consisting of: a hydroxyl (hydroxide) group, a carboxyl group, an amino group, and a glycidoxy (epoxy) group. As to whether or not it has any of these functional groups, it can be confirmed by a Fourier-transform-infrared-spectroscopy equipment (FT-IR equipment), and it can be further quantity-measured by using a titrating method.

The glass transition point (Tg) of the binder resin is desirably set in a range from 55 to 70° C. When the glass transition point of the binder resin is less than 55° C., the obtained toner particles tend to be fused, resulting in the possibility that preservation stability might deteriorate. On the other hand, when the glass transition point of the binder resin exceeds 70° C., there is a possibility that the fixability of the toner might deteriorate. In addition, the glass transition point of the binder resin can be found from a changing point of specific heat by using a differential scanning calorimeter (DSC).

(Colorant)

With respect to the colorant, examples of black pigments include carbon black such as acetylene black, lamp black and aniline black; examples of yellow pigments include chrome yellow, zinc yellow, cadmium yellow, yellow iron oxide, mineral fast yellow, nickel titanium yellow, navel yellow, naphtol yellow S, Hansa Yellow G, Hansa Yellow 10G, benzidine yellow G, benzidine yellow GR, Quinoline Yellow Lake, Permanent Yellow NCG, Tartrazine lake; examples of orange pigments include red chrome yellow, molybdenum orange, permanent orange GTR, pirazolone orange, Vulcan Orange, Indanthrene Brilliant Orange RK, Benzidine Orange G, Indanthrene Brilliant Orange GK; red pigments include iron oxide red, cadmium red, minium, cadmium mercury sulfide, permanent red 4R, resole red, pirazolone red, watching red calcium salt, Lake Red D, Brilliant Carmine 6B, Eoshin Lake, Rhodamine Lake B, alizarine lake, Brilliant Carmine 3B; examples of violet pigments include manganese violet, Fast Violet B and Methyl Violet Lake; examples of blue pigments include Prussian blue, cobalt blue, Alkali Blue Lake, Victoria Blue Lake, Phthalocyanine Blue, Non-metal Phthalocyanine Blue, Phthalocyanine-Blue partial chloride, Fast Sky Blue and Indanthrene Blue BC; green pigments include Chrome Green, chromium oxide, Pigment Green B, Marakite Green-Lake and Final Yellow Green G; examples of white pigments include zinc oxide, titanium oxide, antimony white, zinc sulfide; and examples of white pigments also include baryte powder, barium carbonate, clays, silica, white carbon, talc and alumina white. These pigments are preferably used in a range from 2 to 20 parts by mass, more preferably, from 5 to 15 parts by mass, based on 100 parts by mass of the binder resin.

Other additives may be added to the developer of the present invention within a range that would not impair effects of the present invention. For example, these additives include wax, a charge control agent and the like.

(Wax)

With respect to the wax, although not particularly limited, examples thereof include: plant waxes such as carnauba wax, sugar wax and tree wax; animal waxes such as honey wax, insect wax, whale wax and wool wax; synthetic hydrocarbon-based wax which has ester to a side chain, such as Fischer-Tropsch wax (FT wax), polyethylene wax and polypropylene wax. Among these, it is desirable to use carnauba wax, FT wax with ester attached to a side chain and polyethylene wax, from the viewpoint of dispersibility.

Here, those waxes that have a heat absorbing main peak in a range from 70 to 100° C. in the heat absorbing curve obtained by a differential scanning calorimeter are preferably used. When the heat absorbing main peak is less than 70° C., there is a possibility that toner blocking and hot offset might occur, and, in contrast, when the heat absorbing main peak exceeds 100° C., there is a possibility that low-temperature fixability might not be acquired.

Moreover, the amount of addition of wax is preferably set in a range from 0.1 to 20 parts by mass based on 100 parts by mass of the binder resin. When the amount of addition of wax is less than 0.1 parts by mass, there is a possibility that the sufficient effect of wax is hardly acquired, and, in contrast, when the amount of addition exceeds 20 parts by mass, there is a possibility that the blocking resistant property is lowered and separation of toner from the toner base material might occur.

(Charge Control Agent)

With respect to the charge control agent, a conventionally-known charge control agent may be used, and examples of the positively chargeable charge control agent include nigrosine dye, fatty acid modified nigrosine dye, carboxyl group-containing fatty-acid modified nigrosine dye, a quarternary ammonium salt, an amine-based compound and an organic metallic compound, and examples of the negatively chargeable charge control agent include a metal complex of oxycarboxylic acid, a metal complex of an azo compound, metal complex dye and salicylic acid derivatives.

(External Additive Agent)

With respect to the external additive agents that are used for adjusting the toner charge controlling property and flowability, inorganic fine particles, such as silica, titanium oxide, alumina, zinc oxide, magnesium oxide and calcium carbonate; organic fine particles, such as polymethyl methacrylate; and fatty acid metal salt, such as zinc stearate, may be used. One kind of these may be used, or two or more kinds of these may be used in combination. The amount of addition of the external additive agents is preferably set in a range of 0.1 to 5.0% by mass. The mixing process between the external additive agents and the toner particles may be carried out by using, for example, a Henschel mixer, a V-type mixer, a Turbuler mixer and a Hybridizer.

The surface of the inorganic fine powder may be untreated, or maybe treated on demand by using a silane coupling agent, amino silane, silicone oil or a titanate coupling agent, so as to add a hydrophobic property, or to control its charging property and the like.

The amount of these surface treatment agents is preferably set in a range of 0.05 to 20 parts by weight based on 100 parts by weight of the external additive agents.

With respect to the silane coupling agent, examples thereof include: organo alcoky silanes (for example, methoxymethyl silane, dimethoxydimethyl silane, trimethoxymethyl silane, ethoxytrimethyl silane, etc.); organo chlorosilanes (for example, trichloromethyl silane, dichlorodimethyl silane, chlorotrimethyl silane, trichloroethyl silane, dichlorodiethyl silane, chlorotriethyl silane and trichlorophenyl silane, etc.); organo silazanes (for example, triethyl silazane, tripropyl silazane, triphenyl silazane, etc.); organo disilazanes (for example, hexamethyl disilazane, hexaethyl disilazane, hexaphenyl disilazane, etc.); and other organo silanes. One kind of these may be used alone, or two or more kinds of these may be used in combination. Among the above-mentioned silane coupling agents, organo chlorosilanes, organo silazanes and organo disilazanes are desirably used.

With respect to amino silanes, examples thereof include: N-2 (aminoethyl) 3-aminopropylmethyldimethoxy silane, N-2 (aminoethyl) 3-aminopropyltrimethoxy silane, N-2 (aminoethyl) 3-aminopropyltriethoxy silane, 3-aminopropyltrimethoxy silane, 3-aminopropyltriethoxy silane and N-phenyl-3-aminopropyltrimethoxy silane. Among the above-mentioned amino silanes, 3-aminopropyltrimethoxy silane is desirably used.

With respect to the silicone oil, examples thereof include dimethyl silicone oil, methylphenyl silicone oil, methylhydrodiene silicone oil, fluorosilicone oil and modified silicone oil. One kind of these may be used alone, or two or more kinds of these may be used in combination. If necessary, the above-mentioned silicone oils may be cured by using a crosslinking agent or a thermal treatment. Among the above-mentioned silicone oils, dimethyl silicone oil is desirably used.

With respect to the titanate coupling agent, examples thereof include: isopropyltriisostearoyl titanate, isopropyltricumylphenyl titanate, tetraisopropyl bis(dioctylphosphite) titanate. One kind of these may be used alone, or two or more kinds of these may be used in combination. Among the above-mentioned titanate coupling agents, isopropyltriisostearoyl titanate is desirably used.

(Carrier)

With respect to the material for a carrier core to be used in the present invention, not particularly limited, conventionally known two-component carriers for use in electrophotography may be used. Examples thereof include: ferrite, magnetite, and metals such as iron, nickel and cobalt, and an alloy or a mixture between the above-mentioned metals or the like and metals, such as copper, zinc, antimony, aluminum, lead, tin, bismuth, beryllium, manganese, magnesium, serene, tungsten, zirconium and vanadium, as well as metal oxides between the above-mentioned ferrite or the like and iron oxide, titanium oxide and magnesium oxide, nitrides between the above-mentioned ferrite or the like and chromium nitride and vanadium nitride, mixtures between the above-mentioned ferrite or the like and carbide such as silicon carbide and tungsten carbide, and ferromagnetic ferrite and the like.

With respect to the particle size of the carrier, in general, those having an average particle size in a range of 20 to 200 μm, in particular, in a range of 30 to 150 μm when measured by an electron microscopic method, are preferably used. Here, in general, the apparent density of the carrier is preferably set in a range from 2.4 to 3.0 g/cm³, although it defers depending on the composition of the magnetic material, the surface structure and the like, when it is mainly composed of a magnetic material.

(Image Forming Apparatus)

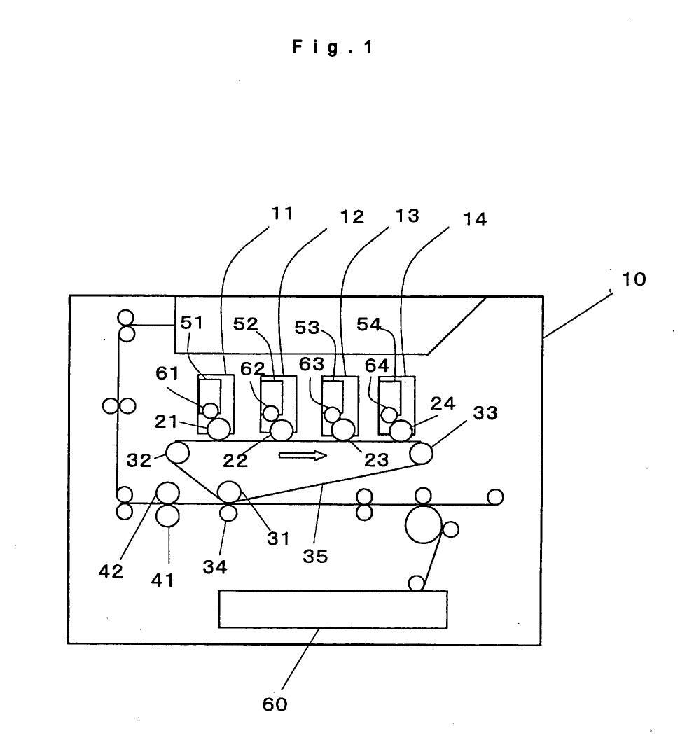

The following description will discuss a color image forming apparatus to which the full-color developer of the present invention is desirably applicable. FIG. 1 is a schematic cross-sectional view that shows an example of the color image forming apparatus of a tandem system (indirect transfer tandem system) in which four photosensitive drums (electrostatic latent image supporting members) are arranged on an intermediate (primary) transfer belt 35 (transferring member).

As shown in FIG. 1, in a housing 10 of this image forming apparatus, an intermediate transfer belt 35, which is passed along rollers 31, 32 and 33 so as to run thereon, is placed, and four image forming units 11, 12, 13 and 14 are installed over the intermediate transfer belt 35 in the order of toner image transferring processes (successively from the upstream side).

Each of the image forming units 11, 12, 13 and 14 has a structure in which a charging device (not shown), an exposing device (not shown), a developing device 51, 52, 53 or 54, and a cleaning device (not shown) are respectively placed on the periphery of a photosensitive drum (image-supporting member) 21, 22, 23 or 24. These photosensitive drums 21, 22, 23 and 24 are arranged in succession along the transferring direction of the intermediate transfer belt 35.

The developing device 51 in the image forming unit 11 is provided with a developing sleeve 61 and a stirring device, and a blade, which regulates the amount of developer to be transported to the developing unit, and frictionally charges the developer, is installed on the upper side of the developing sleeve 61, with a predetermined distance separated from the developing sleeve 61. Moreover, a toner hopper is installed above the stirring member. Toner (magenta toner) having an average circularity C1 is housed in this toner hopper. The other image forming units 12, 13 and 14 have the same structure as the image forming unit 11. In the respective toner hoppers of the image forming units 12, 13 and 14, cyan toner having an average circularity C2, yellow toner having an average circularity C3 and black toner having an average circularity C4 are respectively housed. The toner is mixed with a carrier that is resistance-adjusted by each of the stirring members, and used as a developer.

The following description will discuss image forming processes of the above-mentioned image forming apparatus. For example, in the image forming unit 11, first, the surface of the photosensitive drum 21 is charged evenly with a positive polarity by the charging device. Next, an electrostatic latent image is formed on the surface of the photosensitive drum 21 by the exposing device.

In the developing device 51 in the image forming unit 11, the toner is stirred and mixed with a carrier by the stirring member, and successively supplied to the developing sleeve 61. The toner and carrier thus supplied forms a developer layer on the developing sleeve 61. The developer on the developing sleeve 61 is sent to the position opposing (developing unit) to the photosensitive drum 21 by the anticlockwise rotation of the developing sleeve 61. At this time, the amount of the developer sent to the developing unit is regulated by the blade, with a frictional charge being given to the toner. Thus, the electrically charged toner is allowed to adhere to the electrostatic latent image on the photosensitive drum 21 so that the electrostatic latent image is visualized (developed) to form a toner image. In each of the other image forming units 12, 13 and 14, the electrostatic latent images on the photosensitive drums 22, 23 and 23 are visualized to respectively form toner images through the same sequence of processes as described above.

With this image forming apparatus, the toner images, formed into the visible images on the photosensitive drums 21, 22, 23 and 24, are transferred on the surface of the intermediate transfer belt 35 successively from the photosensitive drum 21 on the upstream side. Thus, the full color image transferred on the intermediate transfer belt 35 is transferred (secondary transfer) onto a sheet of copy paper that has been transported between the roll 34 and the transfer roll 31 from a paper feed cassette 60. The toner on the intermediate transfer belt 35 that has not been transferred is removed by the cleaning device. After heat and pressure have been applied to the full color image transferred on the sheet of copy paper in the fixing device equipped with the fixing roller 41 and the fixing roller 42 so that it is fused and fixed onto the sheet of copy paper, the sheet of copy paper is discharged onto the housing 10.

The full color developer of the present invention is also desirably applicable to a color image forming apparatus of a tandem system (direct transfer tandem system) in which the four photosensitive drums (image supporting members) are arranged over a transferring transport belt (transfer member), with a bias charge having a polarity reversed to the charging polarity of the toner being applied to the transfer roller installed on the lower side of the transferring transport belt, so that the toner images of respective colors formed on the photosensitive drums are transferred onto a sheet of copy paper that has been transported on the transferring transport belt, successively from the photosensitive drum on the upstream side.

Here, with respect to the method for developing the electrostatic latent image on each of the photosensitive drums, any of the normal developing method and the reversal developing method may be used, and with respect to the developing system, any of the contact developing system in which the developer layer and the photosensitive drum are made in contact with each other and the jumping developing system in which the two members are not made in contact with each other may be used. From the viewpoint of obtaining high quality images, the reversal developing method is preferably used. In this case, the photosensitive drum is charged to the same polarity as that of the toner, and the charge on the latent image portion is eliminated by exposure. By applying an alternate voltage formed by superposing an alternating current on a direct current between the developing sleeve and the photosensitive drum in the developing unit as a developing bias, the toner in the developer is transferred onto the electrostatic latent image on the photosensitive drum from which the charge has been eliminated so that the electrostatic latent image is visualized as a toner image.

Moreover, with respect to the material for the photosensitive drum applicable to the present invention, not particularly limited, those conventionally known materials can be used. For example, those photosensitive members, such as an amorphous silicon-based photosensitive member, an organic-based photosensitive member, a Se-based photosensitive member, a ZnO photosensitive member and a CdS-based photosensitive member, may be used. Among these, from the viewpoint of durability, the amorphous silicon photosensitive member is desirably used.

### EXAMPLES

The following examples illustrate the manner in which the present invention can be practiced. It is understood, however, that the examples are for the purpose of illustration and the invention is not to be regarded as limited to any of the specific materials or condition therein.

### Example 1

[Preparation of Black Toner (Bk)]

Polyester resin obtained by condensating bisphenol A and fumaric acid
   100 parts by weight
Carbon black MA-100 (manufactured by Mitsubishi Chemical Corporation)
   4 parts by weight
Fischer-Tropsch wax FT-100 (manufactured by Nippon Seiro Co., Ltd.)
   3 parts by weight
Quarternary ammonium-salt compound (manufactured by an Orient chemical Inc.)
   2 parts by weight

After mixing the above-mentioned materials by a Henschel mixer (manufactured by Mitsui Mining Co., Ltd.) for 2 minutes, the resulting mixture was fused and kneaded in a twin-axis extruder so that a toner kneaded matter was prepared. The toner kneaded matter thus obtained was finely pulverized by an air-flow type pulverizer, and classified by an air classifier, and this was then subjected to a conglobating process at 7000 rpm by using a conglobation device F-40; thus, toner particles having an average circularity of 0.96 and a volume average particle size of 8 μm were obtained.

To 100 parts by weight of these toner particles, the following materials were added, and the materials were mixed by Henschel mixer at 3000 rpm for 10 minutes so that a toner was obtained.
Silica particles (TG-820: manufactured by Cabot Co., Ltd.)
   1.0 part by weight
Titanium oxide (TTO-55A: manufactured by Ishihara Sangyo Co.)
   2.3 parts by weight
Zinc stearate (manufactured by NOF Corporation)
   0.1 part by weight

The resulting toner was blended in a ferrite carrier (EF-60B, manufactured by POWDERTECH Co., Ltd.) having an average particle size of 60 μm, coated with a silicone resin (manufactured by Shin-Etsu Silicone Co., Ltd.), so as to have a toner density of 5%, and this was uniformly stirred and mixed to obtain a two-component developer.

[Preparation of Yellow Toner (Y)]

The same processes as those of the black toner were carried out except that in place of carbon black for black toner, 2 parts of yellow pigment was added and that a conglobating process was carried out at 6000 rpm by using a conglobation device F-40 so that an average circularity of 0.94 was obtained; thus, a yellow toner was prepared.

[Preparation of Cyan Toner (C)]

The same processes as those of the black toner were carried out except that in place of carbon black for black toner, 3 parts of cyan pigment was added and that a conglobating process was carried out at 5000 rpm by using a conglobation device F-40 so that an average circularity of 0.93 was obtained; thus, a cyan toner was prepared.

s[Preparation of Magenta Toner (M)]

The same processes as those of the black toner were carried out except that in place of carbon black for black toner, 3 parts of magenta pigment was added and that a conglobating process was carried out at 3000 rpm by using a conglobation device F-40 so that an average circularity of 0.92 was obtained; thus, a magenta toner was prepared.

Here, the first toner to be subjected to the developing process is magenta toner, and the second to fourth toners are respectively subjected thereto in the order of the cyan, yellow and black.

### Example 2

The same processes as those of Example 1 were carried out except that with respect to the black toner, the conglobating process was carried out at 8000 rpm by using a conglobation device F-40 so that an average circularity of 0.97 was obtained; thus, a color toner was prepared.

### Example 3

The same processes as those of Example 1 were carried out except that with respect to the cyan toner, the conglobating process was carried out at 5500 rpm by using a conglobation device F-40 so that an average circularity of 0.94 was obtained; thus, a color toner was prepared.

### Example 4

The same processes as those of Example 1 were carried out except that with respect to the magenta toner, the conglobating process was carried out at 2000 rpm by using a conglobation device F-40 so that an average circularity of 0.90 was obtained; thus, a color toner was prepared.

### Comparative Example 1

The same processes as those of Example 1 were carried out except that with respect to the magenta toner, the conglobating process was not carried out so that an average circularity of 0.88 was obtained; thus, a color toner was prepared.

### Comparative Example 2

The same processes as those of Example 1 were carried out except that by using a conglobation device F-40, the conglobating processes were respectively carried out on the black toner at 3000 rpm, on the yellow toner at 5000 rpm, on the cyan toner at 5500 rpm, and on the magenta toner at 6000 rpm, so that average circularities were respectively set to 0.92, 0.93, 0.94 and 0.96 with respect to the black, yellow, cyan and magenta toners; thus, color toners were prepared.

### Comparative Example 3

The same processes as those of Example 1 were carried out except that by using a conglobation device F-40, the conglobating processes were respectively carried out on the yellow toner at 5000 rpm and on the cyan toner at 5500 rpm so that average circularities of the yellow toner and the cyan toner were respectively set to 0.93 and 0.94; thus, color toners were prepared.

(Measurements on Average Circularity)

With respect to the average circularity of toner particles, measurements were carried out by using a flow-type particle image analyzer (FPIA-2100) manufactured by Cysmex Co., Ltd., and the average circularity of the measured particles was obtained based upon the above-mentioned equation (1), and the total sum of the average circularities of all the measured particles was divided by the number of all the particles so that the resulting value was used as the average circularity of the toner.

<Evaluation Test>

Each of the color toners obtained in Examples 1 to 4 and Comparative Examples 1 to 3 was loaded into a color printer FS-5016N (modified) (with amorphous silicon photosensitive members installed therein) manufactured by KyoceraMita Corp., and the loss-in-character, transferring efficiency and toner scattering were evaluated. The results of evaluations are shown in Table 1.

The evaluation methods and evaluation criteria are shown below:

With respect to the loss-in-character, a character document was outputted and this was visually observed and evaluated under a magnifying glass of 10 times. The evaluation criteria were: When no loss-in-character was observed, this case was evaluated as ⊙; when, although loss-in-character was slightly observed, no problem was raised in practical use, this case was evaluated as ◯; and when much loss-in-character was observed with problems in practical use, this case was evaluated as.

With respect to the transferring efficiency, the amount of reduction in the toner container, the weight of the developing device and the amount of recovered toner in the waste toner box were measured, and the corresponding value was found by the following equation (2). The evaluation criteria were: When the transferring efficiency was 91% or more, this case was evaluated as ◯; when the transferring efficiency was in a range from 90% or more to less than 91%, this case was evaluated as Δ; and when the transferring efficiency was less than 90% , this case was evaluated as ×.
Transferring efficiency={(A−B)/A} 100 (2)

Here, A: weight of toner container before the test−weight of toner container
after the test; and B: weight of waste toner

With respect to the toner scattering, after endurance image-output tests of 100,000 copies had been carried out on an image with a printed character ratio of 5%, the amount of toner accumulated below the developing sleeve was measured. The evaluation criteria were: When the amount of toner accumulated below the developing sleeve was less than 0.5 g, this case was evaluated as ◯; when the amount of toner was in a range from 0.5 g or more to less than 1.0 g, this case was evaluated as Δ; and when the amount of toner was 1.0 g or more, this case was evaluated as ×.

TABLE 1

| | | Average | | Transferring | |
|---|---|---|---|---|---|
| | | circularity | Character loss | efficiency | Scattering |
| Example 1 | Bk | 0.96 | ⊚ | ◯ | ◯ |
| | Y | 0.94 | | ◯ | |
| | C | 0.93 | | ◯ | |
| | M | 0.92 | | ◯ | |
| Example 2 | Bk | 0.97 | ⊚ | ◯ | Δ |
| | Y | 0.94 | | ◯ | |
| | C | 0.93 | | ◯ | |
| | M | 0.92 | | ◯ | |
| Example 3 | Bk | 0.96 | ◯ | ◯ | ◯ |
| | Y | 0.94 | | ◯ | |
| | C | 0.94 | | ◯ | |
| | M | 0.92 | | ◯ | |
| Example 4 | Bk | 0.96 | ◯ | ◯ | ◯ |
| | Y | 0.94 | | ◯ | |
| | C | 0.93 | | ◯ | |
| | M | 0.90 | | Δ | |
| Comparative | Bk | 0.96 | ◯ | ◯ | ◯ |
| Example 1 | Y | 0.94 | | ◯ | |
| | C | 0.93 | | ◯ | |
| | M | 0.88 | | X | |
| Comparative | Bk | 0.92 | X | ◯ | ◯ |
| Example 2 | Y | 0.93 | | ◯ | |
| | C | 0.94 | | Δ | |
| | M | 0.96 | | X | |
| Comparative | Bk | 0.96 | X | ◯ | ◯ |
| Example 3 | Y | 0.93 | | ◯ | |
| | C | 0.94 | | Δ | |
| | M | 0.92 | | ◯ | |

As shown in Table 1, in Comparative Example 1, since the average circularity of toner (M) in the first developing process was less than 0.89, a loss-in-character occurred, resulting in degradation in the transferring efficiency. Moreover, in Comparative Example 2, since the average circularity was out of the range of the present invention in the first to fourth developing processes, a loss-in-character occurred, resulting in degradation in the transferring efficiency. In Comparative Example 3, since the average circularity of the toner in each of the third and fourth developing processes (C, Y) was set out of the range of the present invention, a loss-in-character occurred.

In contrast, in Examples 1 to 4 in which the range of the present invention was kept, no loss-in-character occurred as shown in Table 1, the transferring efficiency was desirable in all the first to fourth developing processes, and no toner scattering was observed.

It is further understood by those skilled in the art that the foregoing description is a preferred embodiment of the disclosed image forming apparatus and that various changes and modifications may be made in the invention without departing from the spirit and scope thereof.

1. An image forming apparatus comprising:
a plurality of electrostatic latent image supporting members that are placed along a moving direction of a transferring medium, and successively transfers a toner image on the transferring medium; and
a plurality of developer supporting members that supply each of toners onto the electrostatic latent image supporting members so as to form toner images thereon,
wherein each of the toners has an average circularity Cn of 0.89 or more (Cn indicates an average circularity of the toner to be transferred in the n-th time, where n is an integer of 1 to N, with N indicating the total number of colors of the toners that form an image), with C1≦C2≦ . . . ≦CN and C1<CN (where N>1) being respectively satisfied.

2. The image forming apparatus according to claim 1, wherein the electrostatic latent image supporting member is an amorphous silicon photosensitive member.

3. The image forming apparatus according to claim 1, wherein the image forming apparatus is of a color 4-drum tandem developing type.

4. The image forming apparatus according to claim 3, wherein, when N is 4, C1 is in a range of 0.89 to 0.92, C2 is in a range of 0.91 to 0.94, C3 is in a range of 0.93 to 0.96, and C4 is in a range of 0.95 to 0.98.

5. The image forming apparatus according to claim 1, wherein the average circularity of the toner is obtained from the following equation (1).
Average circularity C=L₀/L, (1)
where L₀ represents the peripheral length of a circle having the same projection area as the particle image, and L represents the peripheral length of the particle image.

6. The image forming apparatus according to claim 1, wherein the image forming apparatus uses a two-component full-color developer comprising the toner and a carrier.

7. The image forming apparatus according to claim 6, wherein a toner density in the two-component full-color developer is set in a range from 1 to 20% by mass.

8. An image forming method to form a color image comprising the steps of:
electrically charging a surface of each of a plurality of electrostatic latent image supporting members being aligned along a moving direction of a primary transferring member;
exposing the charged surface of each electrostatic latent image supporting member to form a latent image thereon;
developing the latent image formed on each of the electrostatic latent image supporting members to form a toner image thereon;
primarily transferring the toner images on the primary transferring member to form a full-color toner image thereon;
secondarily transferring the full-color toner image on a secondary transferring member; and
removing residual toner from the primary transferring member after the secondary transferring step,
wherein each of the toners has an average circularity Cn of 0.89 or more (Cn indicates an average circularity of the toner to be transferred in the n-th time, where n is an integer of 1 to N, with N indicating the total number of colors of the toners that form an image), with C1≦C2≦ . . . ≦CN and C1<CN (where N>1) being respectively satisfied.

9. The image forming method according to claim 8, wherein the electrostatic latent image supporting member is an amorphous silicon photosensitive member.

10. The image forming method according to claim 8, wherein an image forming system of a color 4-drum tandem developing type is used.

11. The image forming method according to claim 8, wherein, when N is 4, C1 is in a range of 0.89 to 0.92, C2 is in a range of 0.91 to 0.94, C3 is in a range of 0.93 to 0.96, and C4 is in a range of 0.95 to 0.98.

12. The image forming method according to claim 8, wherein the average circularity of the toner is obtained from the following equation (1).
Average circularity C=L₀/L , (1)
where L₀ represents the peripheral length of a circle having the same projection area as the particle image, and L represents the peripheral length of the particle image.

13. The image forming method according to claim 8, wherein a two-component full-color developer comprising the toner and a carrier is used.

14. The image forming method according to claim 13, wherein a toner density in the full-color two-component developer is set in a range from 1 to 20% by mass.

15. The image forming apparatus according to claim 2, wherein the image forming apparatus is of a color 4-drum tandem developing type.
